(19) United States
(12) Patent Application Publication
(10) Pub. No.: US 2012/0240860 A1
(43) Pub. Date: Sep. 27, 2012

(54) Pet Bed Sheet

(76) Inventor: Ainla Suplina, Dover Plains, NY (US)

(21) Appl. No.: 13/429,766

(22) Filed: Mar. 26, 2012

Related U.S. Application Data
(60) Provisional application No. 61/467,651, filed on Mar. 25, 2011.

(51) Int. Cl. A01K 29/00

(52) U.S. Cl. 119/28.5

(57) ABSTRACT

An architecture is presented that provides a fitted sheet for a pet bed that is easy to apply to and remove from a variety of conventional pet beds. The protective sheet is designed to maintain a form-fitting shape around the pet bed. The protective sheet is easy to apply or remove with little skill or effort. Once applied, the protective sheet is held in place without the need for a zipper.

### CROSS-REFERENCE

This application claims priority from Provisional Patent Application Ser. No. 61/467,651 filed on Mar. 25, 2011.

### FIELD OF THE INVENTION

This invention pertains generally to a protective light-weight washable sheet for a pet bed with an elasticized edge, and more particularly to an easily removable fitted sheet for a dog bed that allows a user to substantially encapsulate the dog bed without having to struggle with the original heavy zippered cover, thereby improving the ease of placing and removing the protective sheet for cleaning.

### BACKGROUND

Traditional pet beds may come with a zippered slip cover that can be removed and washed in the laundry. It is generally more convenient to remove the zippered slip cover from the pet bed in order to clean off dog hair and built-up pet odors than to attempt to wash the entire pet bed. However, it can be cumbersome and unwieldy to struggle with zipping and unzipping the slip cover each time it requires cleaning. As a result, many pet owners, especially those with poor dexterity such as owners with arthritis, do not wash the slip cover as often as they may want creating a stench from pet odor and a buildup of pet hair. This can be embarrassing for guests as well as unsanitary for anyone that comes in proximity of the pet bed. Additionally, as pet beds typically become part of the décor of the room, there is no simple way to add any personal style or decoration to standard zippered pet bed coverings. The present invention allows for personalization of traditional pet beds without the need to purchase a new pet bed every time the owner updates a living space housing a pet.

Consequently, there is a need for a simple and easy way to allow pet owners to keep their pet beds clean more frequently and with more ease than struggling with the original zippered bed cover. The present invention discloses a protective cover for a pet bed that is easy to remove when dirty for cleaning and easy to reapply once cleaned. Additionally, the ease in removal and replacement allows individuals the option of frequent removal between washes so that the protective cover may be shook out or brushed out and replaced without having to struggle with a zipper.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a fitted sheet for use in covering and protecting a pet bed. The fitted sheet comprises a sheet element and a perimeter seam element. The fitted sheet may comprise a variety of shapes and designs to accommodate most existing conventional pet beds and user design preferences. Additionally the perimeter seam element is elastically adjustable so that the fitted sheet may easily substantially encapsulate the pet bed, yet remain in place once applied. The perimeter seam element is easily adjusted between a stretched position and a relaxed position permitting easy application and removal of the fitted sheet without the need to manipulate a zipper or buttons. The ease of application and removal of the fitted sheet increase the likelihood that a user will wash the fitted sheet more frequently creating a cleaner and healthier environment for both the pet and the owner.

Furthermore, the fitted sheet comprises a sheet element further comprising a top portion and a surrounding portion. The surrounding portion preferably is a box band of material sewn to the top portion creating a form-fitted appearance once applied. The perimeter seam element is sewn to the box band so that the fitted sheet is adjustable. In addition, the fitted sheet may be customized to accommodate a variety of different sized and shaped pet beds and a variety of decorative designs.

To apply the fitted sheet to the pet bed, the perimeter seam element may first be stretched to define an opening capable of receiving the pet bed, the pet bed may then be inserted through the opening, and the perimeter seam element may be relaxed so that the opening is now small enough to hold the fitted sheet in place around a substantial portion of the pet bed. To remove the fitted sheet from the pet bed, the perimeter seam element is re-stretched and the pet bed is removed through the opening.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a fitted sheet in conjunction with a rectangular dog bed accordance with the disclosed architecture.

FIG. 2 illustrates a bottom view of the fitted sheet in conjunction with the rectangular dog bed in accordance with the disclosed architecture.

FIG. 3A illustrates a perspective view of the fitted sheet in conjunction with an oval dog bed in accordance with the disclosed architecture.

FIG. 3B illustrates a bottom view of the fitted sheet in conjunction with the oval dog bed in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

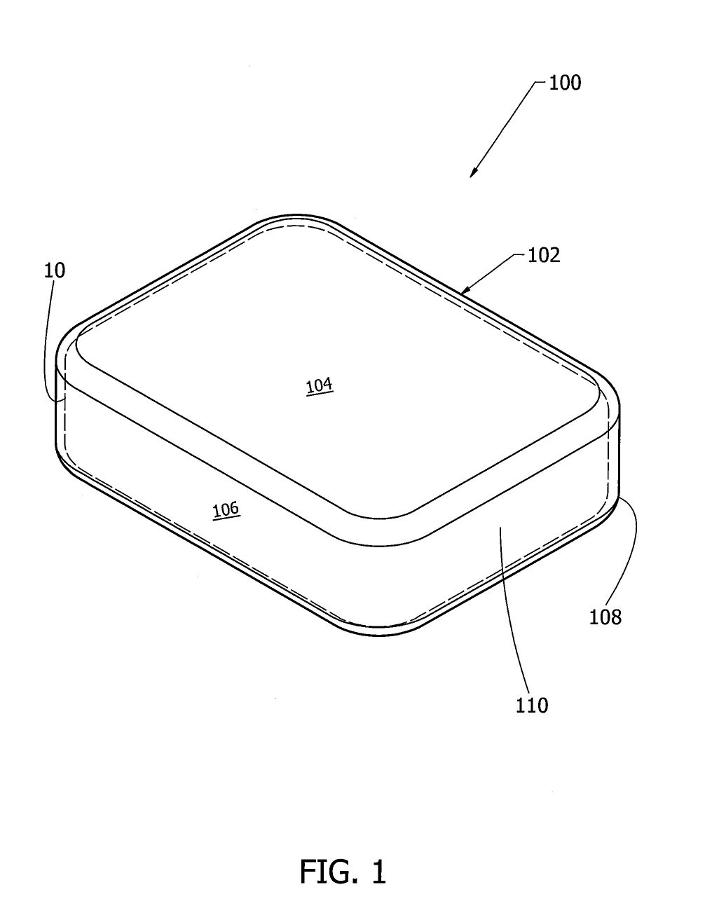

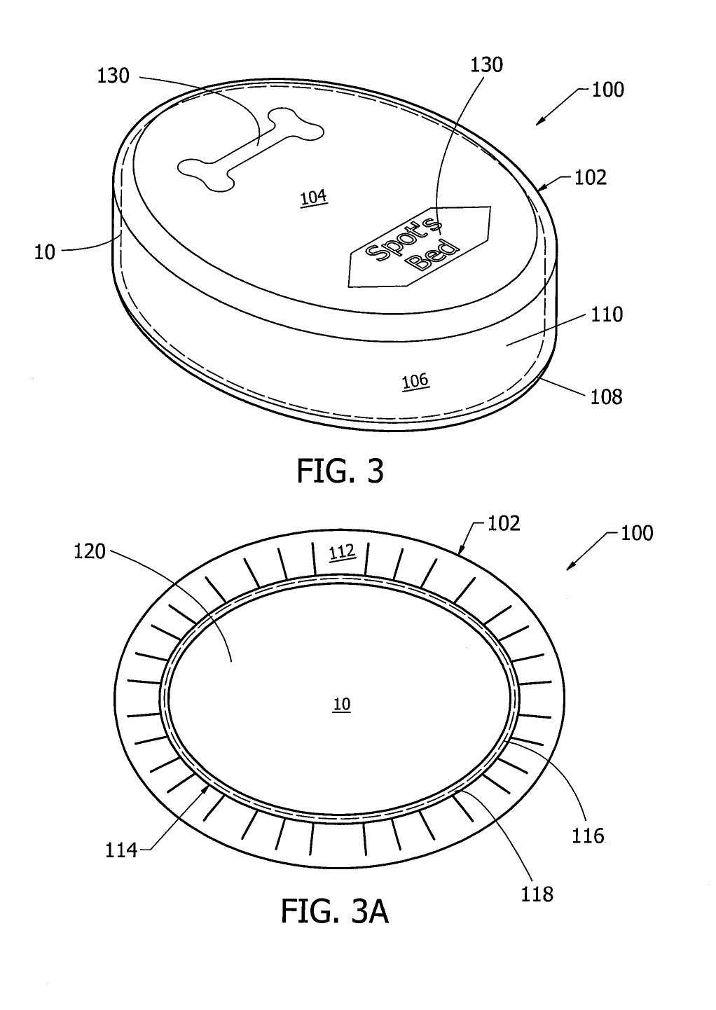

Referring initially to the drawings, FIGS. 1 and 3 illustrate a perspective view of a fitted sheet 100 for covering and protecting a pet bed 10 (shown in dotted lines). Traditional pet beds typically include an inner mattress or cushion and an outer slip covering usually held in place around the inner mattress or cushion with a zipper. Pet owners often desire to provide a sleeping or resting surface for dogs, cats, pot belly pigs, primates, or other domesticated animals. A wide variety of these pet beds exist in the form of mattresses, pillows, cushions, and the like.

The fitted sheet 100 comprises a sheet element 102 configured to cover a substantial portion of the pet bed 10 and a perimeter seam element 114 for adjustably attaching the fitted sheet 100 to the pet bed 10. The fitted sheet 100 is typically substantially a single layer of material, however this is not meant as a limitation as the inventor contemplates that embodiments using a plurality of layers of material are a part of the invention. For example, a multilayered embodiment may be desirable during cooler months for providing additional warmth.

Furthermore, as the pet bed 10 may comprise a wide variety of shapes and sizes, the shape of the fitted sheet 100 may comprise a square, a rectangle, a circle, an oval, and the like, or any other shape or size known to one of skill in the art without affecting the overall scope of the invention. Similarly, the dimensions of the fitted sheet 100 will vary in relation to the dimensions of the pet bed 10. For example, a typical rectangular pet bed 10 as illustrated in FIG. 1, may be approximately 44 inches in length, 34 inches in width, and 6 inches in height. In this example, the fitted sheet 100 would be approximately 45 inches in length, 35 inches in width. and 11 inches in height providing a snug fit once in place.

The sheet element 102 comprises a top portion 104 and a surrounding portion 106. The sheet element 102 is typically a flexible material, preferably a light-weight to medium-weight fabric, but may be manufactured from a variety of different materials such as, but not limited to cotton fabric, cotton-blended fabric, polyester, fleece, light faux fur, and the like. These materials are desirable as they are generally easy to put on or take off the pet bed 10, and are machine washable.

The top portion 104 preferably covers a top side (not shown) of the pet bed 10 and comprises a length and a width of the sheet element 100. The surrounding portion 106 preferably comprises a box band element 108. The surrounding portion 106 is typically sewn to or otherwise attached to a perimeter of the top portion 104.

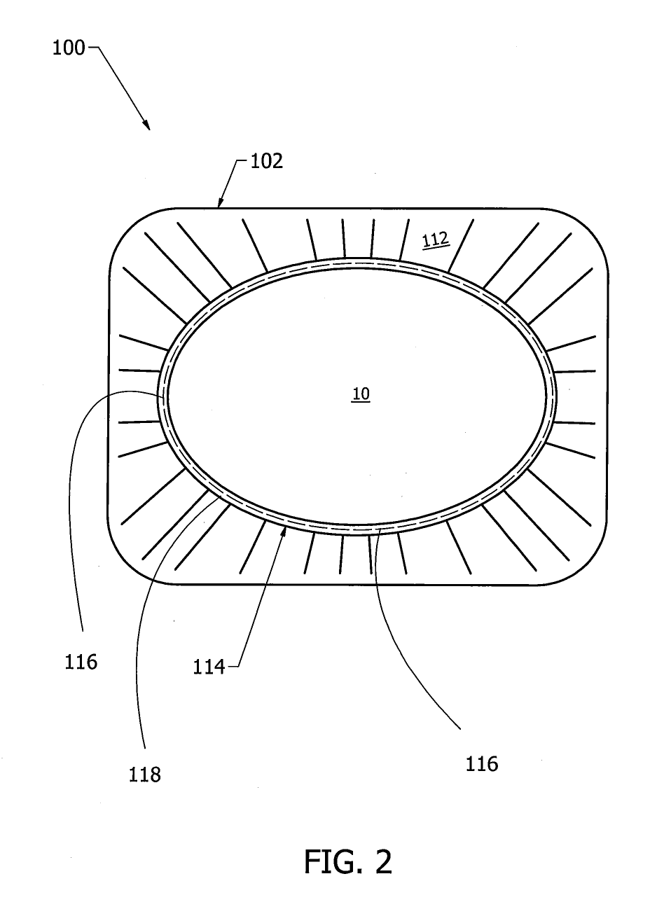

As illustrated in FIGS. 1, 2, 3, and 3A, the box band element 108 comprises a side portion 110, a bottom portion 112, and a folded outer edge 118. The box band element 108 allows the fitted sheet 100 to substantially encapsulate the pet bed 10 by covering a side and/or sides and a portion of the bottom of the pet bed 10. In other words, the side portion 110 surrounds the sides of the pet bed 10, and the bottom portion 112 covers the portion of the bottom of the pet bed 10.

The folded outer edge 118 is typically formed by folding over and sewing in place approximately between ⅛th and ¾th of an inch of an outermost portion of the bottom portion 112 over the adjacent material. In other words, the folded outer edge 118 forms essentially a double layer perimeter of the bottom portion 112 of the box band element 108. The folded outer edge 118 provides an attachment point for the perimeter seam element 114.

The perimeter seam element 114 typically comprises an elastic element 116, such as for example an elastic band. Preferably the elastic element 116 is a strip of approximately ½ inch wide garment elastic that may be sewn on or otherwise attached to the folded outer edge 118, however other similar elastic materials known to those of skill in the art may be used as well. Similarly, the elastic element 116 may be approximately between ⅛th and ¾th of an inch in width and still be considered within the scope of the invention. A preferred embodiment contemplates the elastic element 116 having approximately a two to one ratio of expansion, so that the elastic element 116 essentially expands to approximately double the relaxed length when stretched. However, the only limitation on the elasticity of the elastic element 116 is that the perimeter seam element 114 must expand large enough in a stretched position to be capable of receiving the pet bed 10.

As the perimeter seam element 114 adjustably attaches the fitted sheet 100 to the pet bed 10, the fitted sheet 100 is releasably secured. Traditional pet bed coverings utilize a zipper or other nonadjustable mechanism to secure the covering to the pet bed. While the zipper will secure the covering, it is difficult to manipulate, especially for individuals with limited dexterity such as from arthritis or advanced age. Therefore, the elastic element 116 is advantageous as it permits much easier application and removal of the fitted sheet 100 than traditional coverings.

To attach the elastic element 116 to the folded outer edge 118, the elastic element 116 may be stretched to a non-relaxed position and then sewn or otherwise attached to the folded outer edge 118. Once attached, the elastic element 116 may be relaxed so that the perimeter seam 114 defines an adjustable opening 120. To substantially encapsulate the pet bed 10, the adjustable opening 120 is manipulated by stretching the perimeter seam element 114 to a stretched position which is large enough to accept the pet bed 10 through the adjustable opening 120. After the pet bed 10 is substantially encapsulated, the perimeter seam element 114 is relaxed to a relaxed position which is small enough to hold the fitted sheet 100 snugly in place around the pet bed 10. To remove the fitted sheet 100, the perimeter seam element 114 is re-stretched to the stretched position, and the pet bed 10 is removed through the adjustable opening 120 in the stretched position and the perimeter seam element 114 is then relaxed to the relaxed position.

The fitted sheet 100 may further comprise a decorative design 130. The decorative design 130 may comprise one or more elements, designs, characteristics, colors, and the like. For example, the fitted sheet 100 may be customized with a decorative design 130 such as a color or pattern that fits in with the decor of a room. Similarly, it is contemplated that any number of options for the decorative design 130 may be used as is commonly known in the art, such as but not limited to pictures, words, drawings, decals, patches, and the like without deviating from the scope of the invention.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fitted sheet for covering and protecting a pet bed, the fitted sheet comprising:
a sheet element configured to cover a substantial portion of the pet bed, the sheet element further comprising:
a top portion; and
a surrounding portion; and
a perimeter seam element for adjustably attaching the fitted sheet to the pet bed.

2. The fitted sheet claim 1, wherein the sheet element comprises flexible material.

3. The fitted sheet of claim 2, wherein the flexible material comprises at least one of the following materials: light-weight fabric, medium-weight fabric, cotton fabric, cotton blended fabric, polyester, fleece, or light faux fur.

4. The fitted sheet of claim 1, wherein the sheet element comprises a single layer of material.

5. The fitted sheet of claim 1, wherein the sheet element is configured in the following shapes: a rectangle, a square, an oval, or a circle.

6. The fitted sheet of claim 1, wherein the fitted sheet is washable.

7. The fitted sheet of claim 1, wherein the pet bed comprises at least one of the following: a dog bed, a cat bed, a pillow, a cushion, a primate bed, or a domesticated animal bed.

8. The fitted sheet of claim 1, further comprising a decorative design.

9. The fitted sheet of claim 1, wherein the perimeter seam element comprises an elastic element.

10. A fitted sheet for a dog bed, the fitted sheet comprising:
a sheet element configured to encapsulate a substantial portion of the dog bed, the sheet element further comprising:
a top portion; and
a surrounding portion, wherein the surrounding portion comprises a box band element; and
an perimeter seam element attached to the box band element, wherein the perimeter seam element may adjustably attach the fitted sheet to the pet bed.

11. The fitted cover device of claim 10, wherein the box band element comprises a side portion and a bottom portion.

12. The fitted sheet of claim 11, wherein the bottom portion comprises a folded outer edge.

13. The fitted sheet of claim 12, wherein the folded outer edge is approximately between ⅛^{th} and ¾^{th} inches in width.

14. The fitted sheet of claim 13, wherein the perimeter seam element comprises an elastic element.

15. The fitted sheet of claim 14, wherein the elastic element is approximately between ⅛^{th} and ¾^{th} inches in width.

16. The fitted sheet of claim 15, wherein the elastic element is attached to the perimeter seam element.

17. The fitted sheet of claim 10, wherein the perimeter seam element releasably secures the fitted sheet to the dog bed.

18. The fitted sheet of claim 10, wherein the perimeter seam element defines an adjustable opening.

19. The fitted sheet of claim 18, wherein the adjustable opening when in a stretched position is large enough to receive the dog bed, and when in a relaxed position is small enough to hold the fitted sheet snugly in place around the dog bed.

20. A fitted sheet for a dog bed, the fitted sheet comprising:
a sheet element configured to encapsulate a substantial portion of the dog bed, the sheet element further comprising:
a top portion; and
a surrounding portion, wherein the surrounding portion comprises a box band element; and
an perimeter seam element attached to the box band element, wherein the perimeter seam element comprises a substantially ½ inch wide elastic band that may essentially double in circumference when stretched.
